(19) United States
(12) Patent Application Publication
(10) Pub. No.: US 2013/0098938 A1
(43) Pub. Date: Apr. 25, 2013

(54) WIPES DISPENSER

(71) Applicant: Sotiria Efthimiadis, Valatie, NY (US)

(72) Inventor: Sotiria Efthimiadis, Valatie, NY (US)

(21) Appl. No.: 13/281,243

(22) Filed: Oct. 25, 2011

(51) Int. Cl. B65D 83/08; B65G 59/02

(52) U.S. Cl. 221/45; 221/286

(57) ABSTRACT

A wipes dispenser for wet wipes comprises a cabinet with an exterior structure enveloping an interior space and with a roll back door providing access to the interior space by rolling between an opened position and a closed position. A wipes container within the cabinet houses a wipes bin in the interior space in the cabinet. A mounting structure is formed on the exterior structure of the cabinet. A mounting support is attached for affixing the mounting structure to a support surface.

### BACKGROUND OF THE INVENTION

This invention relates to dispensers for wet wipes and more particularly to containers for wet wipes.

There is a need for wet wipes dispensers containers and wet wipes fixtures in which wet wipes are easily accessible while providing protection of wet wipes stored therein by inhibiting drying thereof.

There is also a need for wet wipes dispensers and wet wipes fixtures with a minimum number of moving parts in which the moving parts are simple, durable, and reliable to assure that the dispenser has a long life and is durable and reliable.

There is also a need for durable and reliable wet wipes dispensers containers and wet wipes fixtures

An object of this invention is to provide a wet wipes fixture that is easily installed on and easily removed from an installation surface.

### SUMMARY OF THE INVENTION

In accordance with this invention, a wipes dispenser for wet wipes comprises a cabinet with an exterior structure enveloping an interior space and with a roll back door providing access to the interior space. A wet wipes container houses a wet wipes bin in the interior space in the cabinet. Preferably, a mounting structure is formed on the cabinet. A mounting support affixes the mounting structure to a support surface. The cabinet includes a rigid supporting structure for installing the wipes bin therein.

It is also preferred that the cabinet includes fins affixed thereto located within the interior space with the fins having notches formed thereon and the wipes bin includes a bottom with ribs formed therein for installation into the notches. A front plate comprising an element of the exterior structure is located below the roll back door in the closed position. A gasket seals surfaces between the cover and the bin with a tab extending from it. The tab of the gasket is bonded to the front plate. The cabinet includes sidewalls. The rollback door and the sidewalls have simple bearings formed therein for supporting rolling of the rollback door between opened and closed positions. The cabinet includes a rigid supporting structure for installing the wipes bin therein. The cabinet includes fins affixed thereto located within the interior space with the fins having notches formed thereon; and the wipes bin includes a bottom with ribs formed therein for installation into the notches. A front plate comprises an element of the exterior structure located below the roll back door in the closed position. The cabinet includes sidewalls with the rollback door and the sidewalls having simple bearings formed therein for supporting rolling of the rollback door between opened and closed positions.

In accordance with another aspect of this invention a wipes dispenser for wet wipes comprises a cabinet with an exterior structure enveloping an interior space and with a roll back door providing access to the interior space. The cabinet includes cabinet sidewalls. The roll back door has a curved front face with a circular radius and a handle thereon and door sidewall. The roll back door is mounted on simple bearings comprising bearing holes in the cabinet sidewalls and pins on the door sidewalls installed in the bearing holes. A wipes container houses a wipes bin in the interior space in the cabinet. A mounting structure is formed on the cabinet. A mounting support is provided for affixing the mounting structure to a support surface. The cabinet includes a rigid supporting structure for installing the wipes bin therein. The cabinet includes fins affixed thereto located within the interior space with the fins having notches formed thereon. The wipes bin includes a bottom with ribs formed therein for installation into the notches.

Preferably, the wipes dispenser includes a front plate comprising an element of the exterior structure located below the roll back door in the closed position; a gasket sealing surfaces between the cover and the bin with a tab extending from it. The tab of the gasket is bonded to the front plate. The bin includes a cover with dispensing dome with a dispensing slit therethrough. The dispensing dome is composed of a soft, flexible plastic. The cabinet and the bin are composed of hard plastic.

### BRIEF DESCRIPTION OF THE DRAWINGS

FIGS. 1A and 1B are front perspective views of an embodiment of this invention comprising a wet wipes dispenser for storing and dispensing stored wet wipes with a rollback door shown in the opened and closed positions respectively.

FIGS. 2A-2E are separate perspective views of component parts of the wipes dispenser of FIGS. 1A and 1B.

FIG. 3A is a front elevation, FIG. 3B is a plan view and FIG. 3C is a right elevation of the wipes dispenser of FIG. 1B with the roll backdoor in the closed position.

FIG. 4A is a front elevational view of the wipes dispenser of FIGS. 1A-1B with the roll back door in the closed position.

FIG. 4B is a front elevational view of the wipes dispenser of FIGS. 1A-1B, and 3A-3C with the roll back door in the opened position, as shown in FIG. 1B.

FIG. 4C is a sectional view of the wipes dispenser of FIGS. 1A-1B, and 3A-3C; 4A and 4B taken along section line 4C-4C of FIG. 3B.

FIG. 4D is a sectional view of the wipes dispenser of FIGS. 1A-1B, and 3A-3C, and 4A-2C taken along section line 4D-4D in FIG. 4C.

FIG. 5A is a perspective view of the front of the cabinet of FIG. 2A with the roll back door opened.

FIG. 5B is a top perspective view of a bin gasket, including a horizontally extending portion with a front tab extending downwardly from it.

FIG. 5C is a top perspective view of the wipes bin assembled with the front plate just below the bin gasket and the front tab in a position ready to be assembled therewith.

FIG. 5D is a top perspective view of the bin cover of the wipes bin and bellows rings of a bin cover adapted to receive a dispensing dome.

FIG. 5E is a top perspective of the dispensing dome of the bin cover with a dispensing slit therethrough provided for dispensing wet wipes through the dispensing dome.

FIG. 5F is a top perspective view of the assembled parts of wipes container of FIGS. 5-5E, with the container juxtaposed with the cabinet of FIG. 5A, ready to be inserted therein.

FIGS. 6A and 6B are rear perspective views of the back of the cabinet of FIG. 1B with the door open. FIG. 6C shows a mounting bracket for supporting the cabinet, with mounting holes through the mounting bracket and a tongue of the mounting bracket for supporting the mounting frame.

FIG. 7A is a sectional view taken along line 7A-7A in FIG. 4A of the wipes dispenser cabinet and the container with the door closed. FIG. 7B is a similar sectional view taken along line 7B-7B in FIG. 4B of the wipes dispenser cabinet and the container with the door open.

### PREFERRED EMBODIMENT OF THE INVENTION

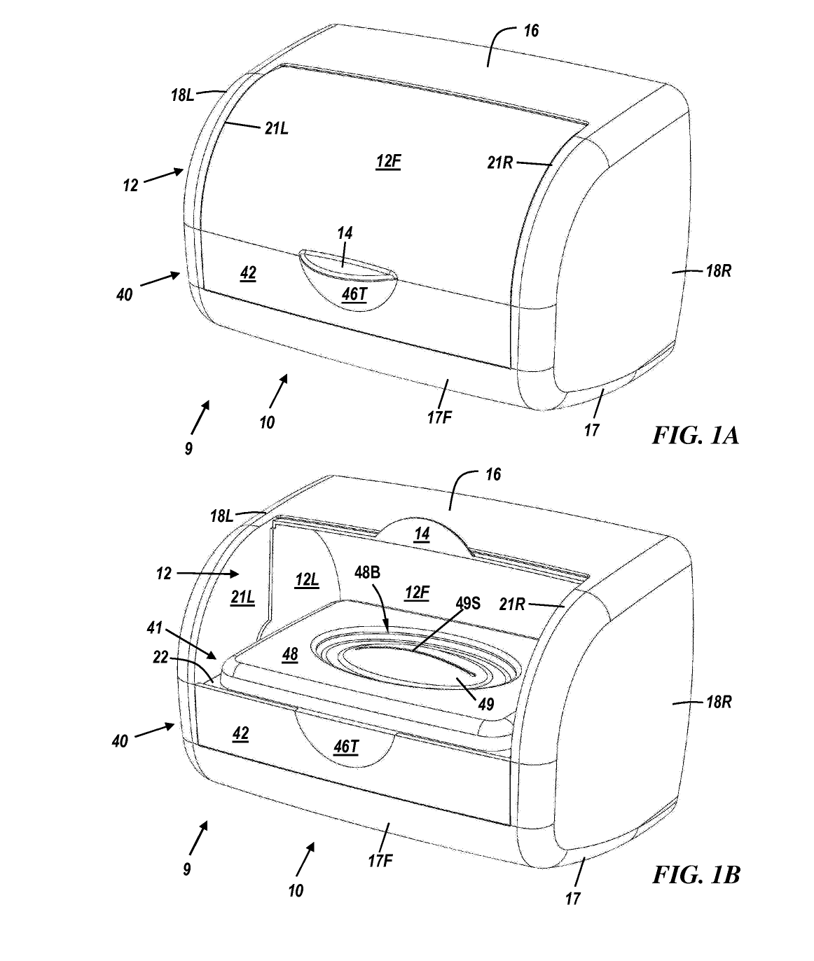

FIGS. 1A and 1B are front perspective views of an embodiment of this invention comprising a wipes dispenser 9 for storing and dispensing wet wipes while protecting the wet wipes from drying therein, with FIG. 1A showing the curved face 12F with a circular radius of a roll back door 12 in the closed position, and FIG. 1B showing the face 12F of the roll back door 12 in the opened position.

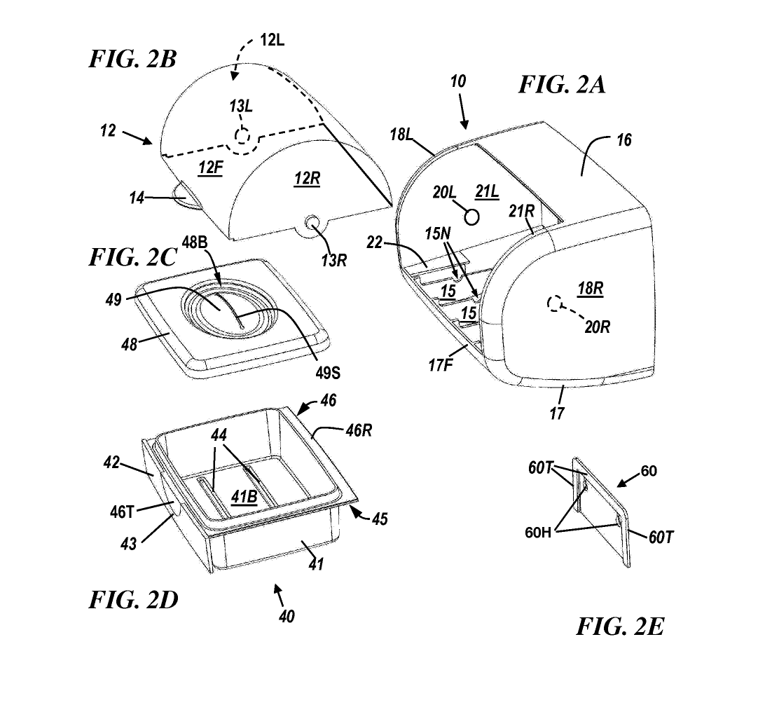

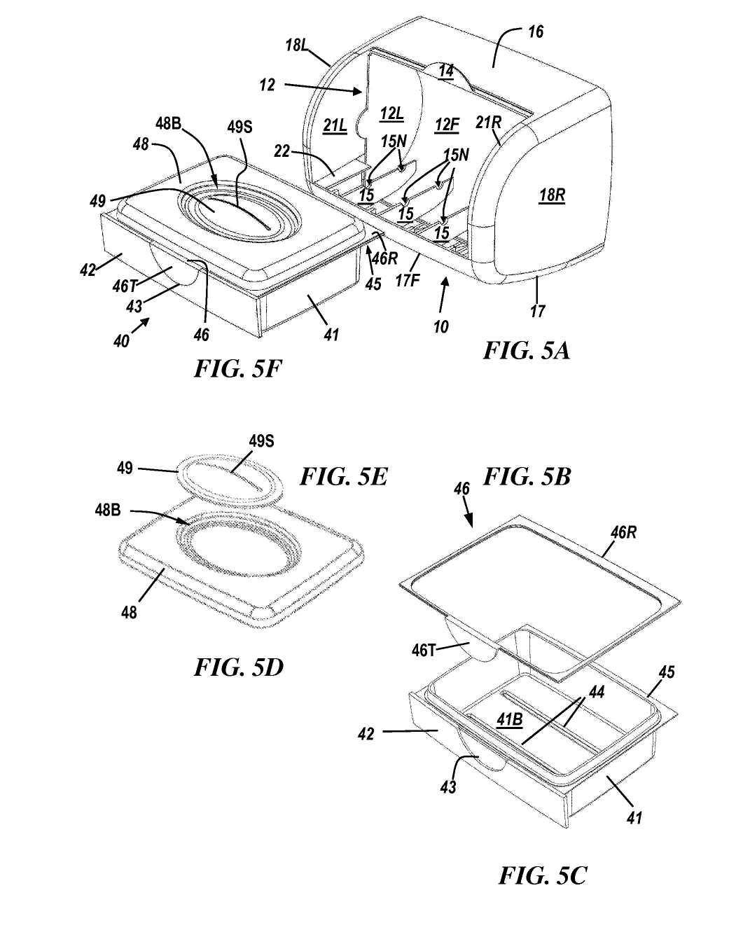

In FIG. 1A the wipes dispenser 9 comprises a cabinet 10 with the roll back door 12, shown in the closed position, and a wipes container 40. Other elements of the cabinet 10 shown include a top 16, a cabinet bottom 17 and the bottom front 17F of the cabinet bottom 17, a left outside cabinet sidewall 18L, the edge of a left inside cabinet inside cabinet sidewall 21L, a right outside cabinet sidewall 18R, the edge of a right inside cabinet inside cabinet sidewall 21R. Parts of the roll back door 12 that are exposed in FIG. 1A are the door face 12F and a door handle 14 that projects forward from the lower edge of the door face 12F. Because the roll back door 12 is closed, only a few parts of the wipes container 40 are shown in FIG. 1A that include a front plate 42 associated with a wipes bin 41 (shown in detail in FIGS. 2D, 5C and 5F) and a front tab 46T bonded to the front plate 42. The front tab 46T is an integral part of a bin gasket 46 (shown in FIG. 5C) provided to seal the wipes bin 41 of the container 40.

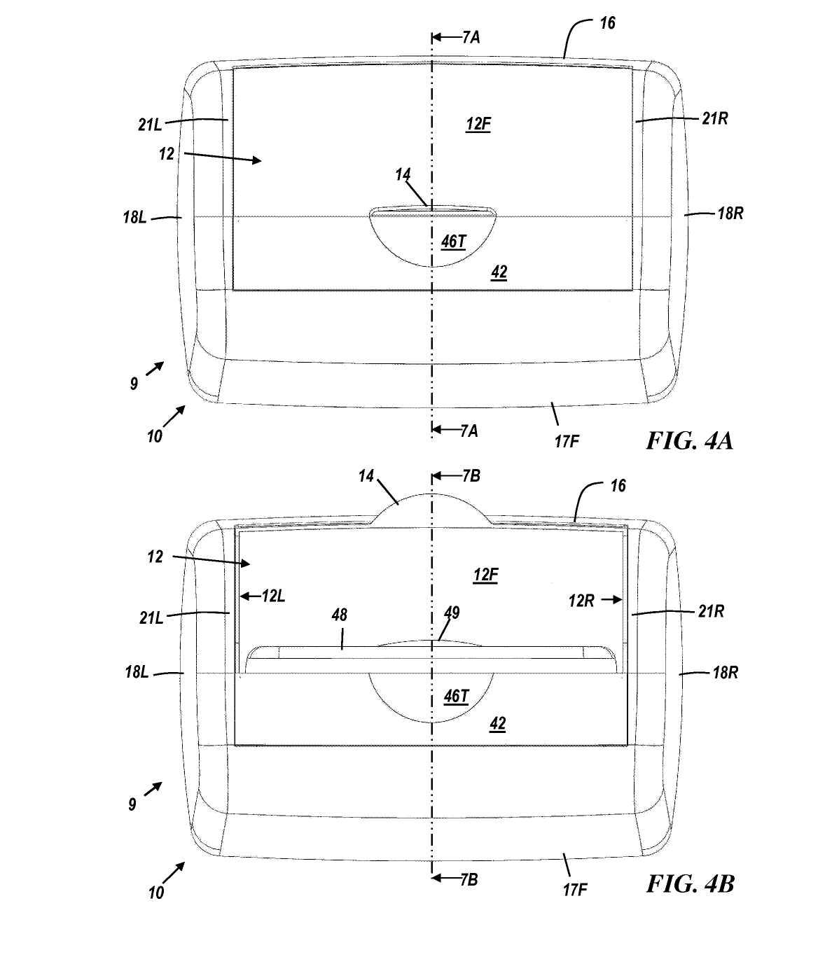

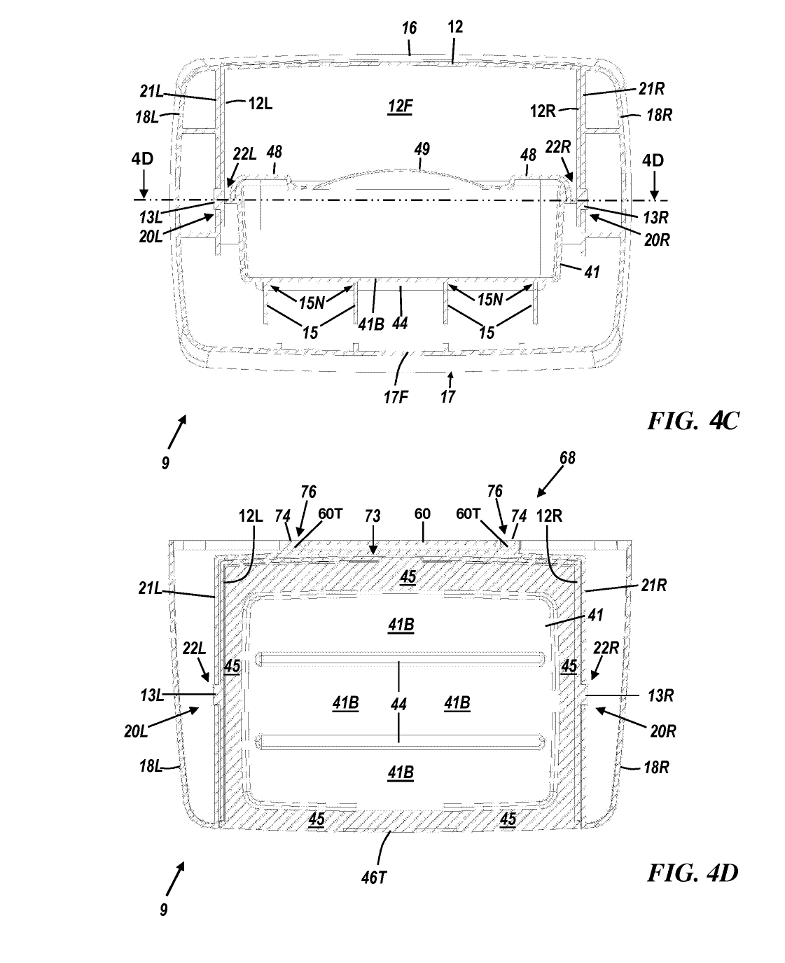

FIG. 1B shows a front perspective view of the wipes dispenser 9 of FIG. 1A with the roll back door 12 in the open, rolled back position. The roll back door 12 is supported for opening and closing by pair of plain bearings 22L/22R shown in detail in FIGS. 4C/4D and described below. In FIG. 1B the roll back door 12 of the cabinet 10 is completely inside the cabinet 10, exposing the inside surface of the left sidewall 12L of the roll back door 12 and the interior surface of the door face 12F and some of the inner surface of the left inside cabinet inside cabinet sidewall 21L of the cabinet 10. The door handle 14 is shown projecting upwardly form the edge of the door face 12F.

Inside the cabinet 10, portions of the impervious wipes container 40 are shown that include an impervious wipes bin 41 with an impervious bin cover 48 for the wipes bin 4. FIG. 1B also shows more parts of wipes container 40 including the wipes bin cover 48 including a central, elliptical recess with expansible bellows rings 48B and a convex surface bonded to a matching, impervious, elliptical, dispensing dome 49, composed of a soft flexible, impervious, material suitable for dispensing wet wipes.

The dispensing dome 49 is provided with a dispensing slit 49S extending along the long axis of the elliptical dispensing dome 49 that narrow slit 49S permits removal of wet wipes from the container 40 while inhibiting excessive drying of the wet wipes stored therein.

FIGS. 2A-2E are separate perspective views of component parts of the wipes dispenser 9 of FIGS. 1A and 1B showing additional features thereof.

FIG. 2A shows the cabinet 10 with the wipes container 40 removed, and shows features such as the surfaces of the left inside cabinet inside cabinet sidewall 21L and the right outside cabinet sidewall 18R. In addition a pair of left/right bearing holes 20L/20R and a pair of left/right inside sidewalls 21L/21R, and an array of support fins 15 are shown. There are two plain bearings 22L/22R that rotatably support the rollback door 12 for rolling it between the opened and closed positions shown in FIGS. 1A/1B respectively.

The left/right bearing holes 20L/20R are cylindrical holes formed in the inside sidewalls 21L/21R respectively of the cabinet 10 and aligned in parallel on the same axis, opposite from each other. The left bearing hole 20L is shown in the left inside cabinet inside cabinet sidewall 21L. The right bearing hole 20R is shown by dotted lines indicating a phantom view in the right inside cabinet inside cabinet sidewall 21R. The bearing holes 20L/20R are cylindrical holes in the inside sidewalls 21L/21R respectively of the cabinet 10 with central axes that are aligned on the same axis line and with the inside sidewalls 21L/21R extending parallel to each other.

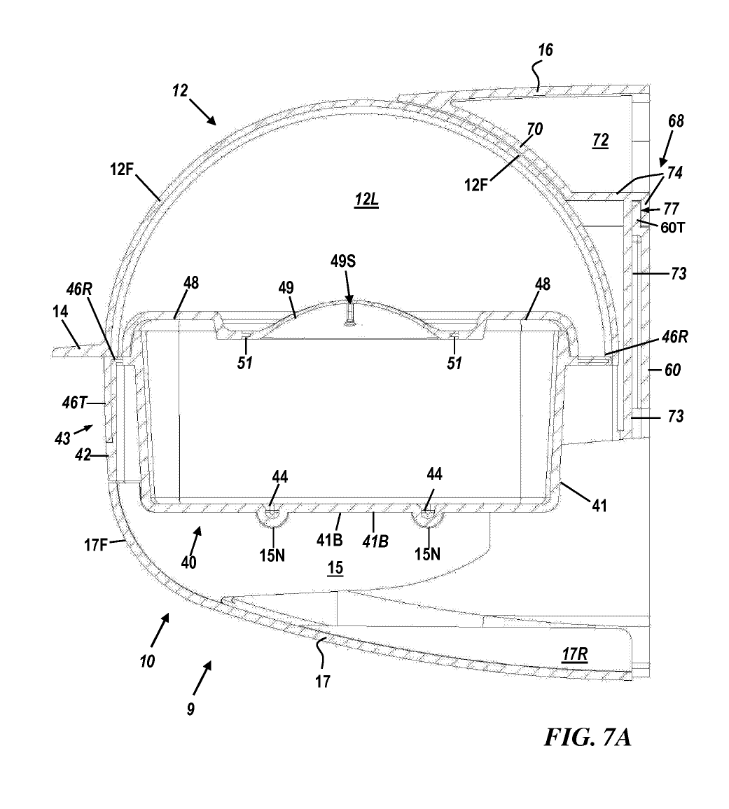

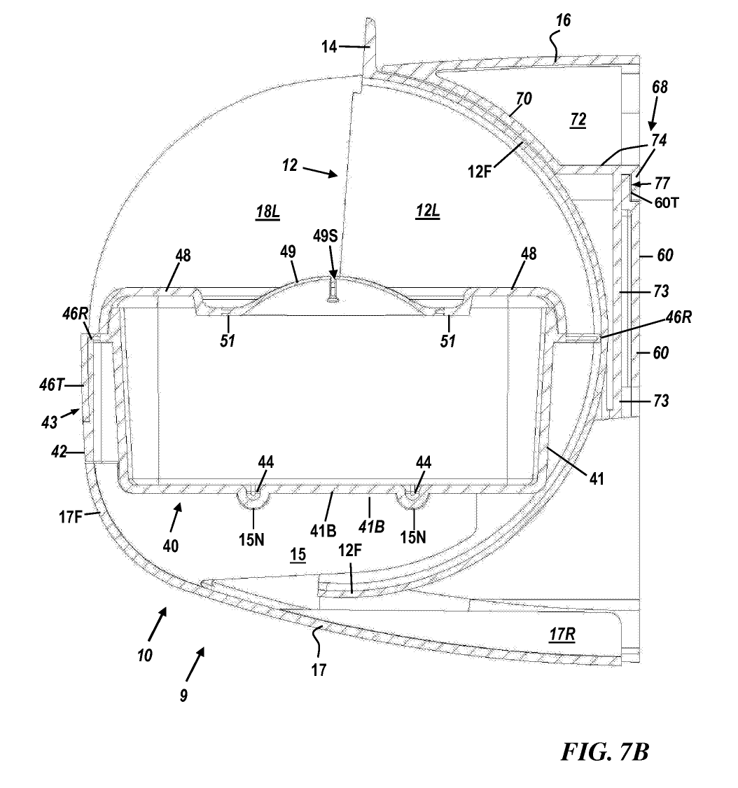

The sets of plain bearings 22L/22R are shown in more detail in the sectional views shown in FIGS. 4C and 4D and are described in more detail below. The array of support fins 15 supports the lower surface of the bottom 41B of the wipes bin 41 shown in FIG. 2D when it is installed. The support fins 15 for the wipes bin 41 are secured to the bottom front 17F of the cabinet 10 and they reach from it towards the rear of the cabinet 10. There are alignment notches 15N in the top edges of the support fins 15 that are provided to hold the bin alignment ribs 44 in the bottom 41B of the wipes bin 41 in position as shown in FIGS. 7A and 7B.

FIG. 2B shows the right sidewall 12R and a phantom view of the left sidewall 12L with sidewalls 12L/12R being parallel with each other. FIG. 2B also shows left/right bearing pins 13L/13R of the plain bearings 22L/22R on opposite sides of the roll back door 12 from each other. The left/right bearing pins 13L/13R of the pair of plain bearings are integral with the exterior surfaces of the left/right sidewalls 12L/12R of the roll back door 12. The cylindrical bearing pins 13L/13R are formed and aligned and spaced apart on the same central axis, on the outside surfaces of the parallel left/right sidewalls 12L/12R of the roll back door 12. In detail, the bearing pin 13L is shown (in phantom) formed on the exterior surface of the left sidewall 12L and the bearing pin 13R is formed on the exterior surface of the right sidewall 12R. The handle 14 is shown on the lower front edge of face 12F of the roll back door 12 as shown in FIG. 1A.

FIG. 2C is a perspective view that shows the wipes bin cover 48 of FIG. 1B, that includes the central, elliptical recess with a convex surface in that a wipes dispensing dome 49 is provided with a dispensing slit 49S extending and centered along the longer axis of the elliptical dispensing dome 49. The bin cover 48 for the wipes bin 4, that is positioned above the wipes bin 41, is provided for storage of wet wipes (not shown) in the wipes container 40, that is shown in FIG. 2D.

FIG. 2D is a perspective view that shows the wipes container 40 including the wipes bin 41, the front plate 42 of the container 40 with a notch 43 in the front plate 42, and a bin gasket 46 for sealing the container 40 that includes a horizontally extending rim 46R with a front tab 46T extending downwardly from it. The bin gasket 46 is composed of a soft, sealing material. The front tab 46T of the bin gasket 46 is bonded to the front plate 42 in the notch 43 and with the border of the bin gasket 46 is bonded to the horizontally extending rim 45 on the periphery of the wipes bin 41. The rim 45 is shown in more detail in FIG. 5C. Formed on the bottom surface of the bottom of the wipes bin 41 are two bin alignment ribs 44 that are hollow inside the wipes bin 41 project downwardly from the bottom exterior surface of the wipes bin 41 having a convex surface on the bottom of the wipes bin 41 are located for insertion into the alignment notches 15N in the array of support fins 15 of the cabinet as shown in FIG. 2A. The bin alignment ribs 44 in the bottom of wipes bin 41 provide for alignment of wipes bin 41 in cabinet 10.

As shown in FIGS. 4C and 4D, the bearing pin 13L is inserted into the bearing hole 20L of the inner left outside cabinet sidewall 18L of cabinet 10; and the bearing pin 13L is inserted into the bearing hole 20R of the inner right outside cabinet sidewall 18R of the cabinet 10. The bearing pins 13L/13R and bearing holes 20L/20R form the pair of plain bearings with the door 12 opening to the rolled back position or with the door 12 closing as the bearing pins 13L/13R turn in the bearing holes 20L/20R.

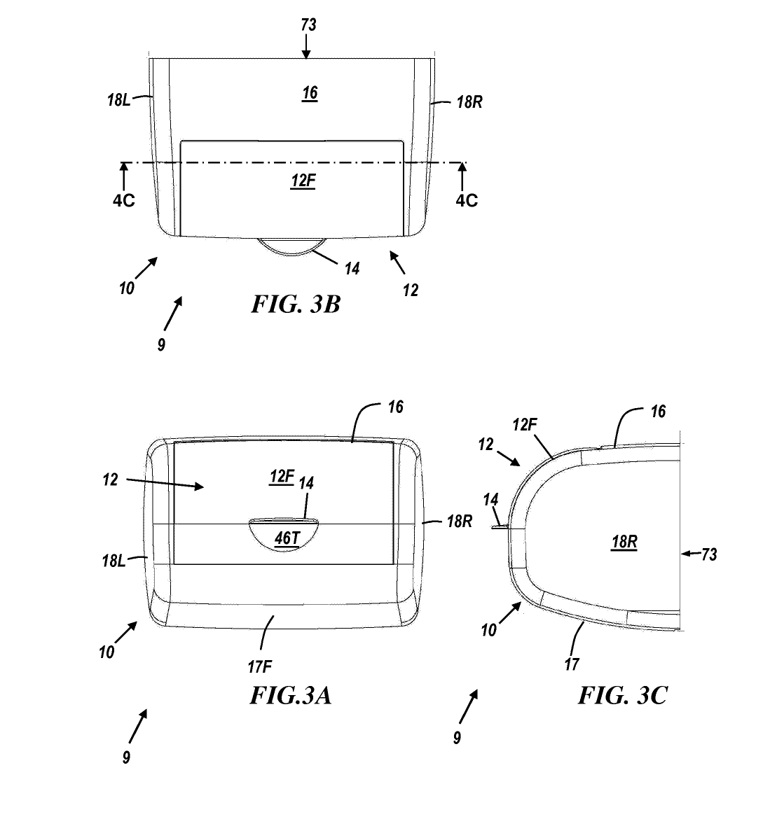

FIG. 3A is a front elevational view of the wipes dispenser 9 of FIGS. 1A and 1B with the roll back door 12 in the closed position showing more of the left outside cabinet sidewall 18L of the cabinet 10. FIG. 3B is a plan view of the wipes dispenser 9 of FIG. 3A. FIG. 3C is a right elevation of the wipes dispenser 9 of FIG. 3A. The features shown in FIGS. 3A-3C have been described above.

FIG. 4D is a sectional view of the wipes dispenser of FIGS. 1A-1B, and 3A-3C, and 4A-2C taken along section line 4D-4D in FIG. 4C.

FIG. 4A is a front elevational view of the wipes dispenser 9 of FIGS. 1A-1B with the roll back door 12 in the closed position, as shown in FIG. 1A. The features shown in FIG. 4A have been described above.

FIG. 4B is a front elevational view of the wipes dispenser 9 of FIGS. 1A-1B, and 3A-3C with the roll back door 12 in the opened position, as shown in FIG. 1B. The features shown in FIG. 4B have also been described above.

FIG. 4C is a sectional view of the wipes dispenser 9 of FIGS. 1A-1B, and 3A-3C; 4A and 4B taken along section line 4C-4C of FIG. 3B. In FIG. 4C the outer left and right walls 18L/18R of the cabinet 10 as well as the inner left and right walls 21L/21R of the cabinet 10 are shown with the top 16 thereabove. The left/right walls 12/12R of the opened roll back door 12 are shown aside from the face 12F of the opened roll back door 12 with walls 12/12R respectively juxtaposed with the respective inner walls 21L/21R of the cabinet 10. The left/right plain bearings 22L/22R include a pair of bearing pins 13L and 13R formed on the exterior surfaces of the left/right sidewalls 12L/12R of the roll back door 12 that pins are housed for rotation in the left and right bearing holes 20L/20R formed respectively in the inner left/right sidewalls 18L/18R of cabinet 10. The left/right plain bearings 22L/22R support the left/right sidewalls 12L/12R of the roll back door 12 for rotation between the normally closed position of door 12 shown in FIGS. 1A, 3A, and 4A and the opened position of door 12 shown in FIGS. 1A and 4B.

Each of the support fins 15 in the array thereof is secured to the bottom front 17F of the cabinet bottom 17 of the cabinet 10 as shown in FIGS. 7A and 7B. The bin alignment ribs 44 (not shown in FIG. 4C) on the bottom 41B of the wipes bin 41 are resting in bin alignment notches 15N in the array of fins 15. The alignment notches 15N are also shown in FIGS. 4A, 5A and 7A and 7B. The bin cover 48 of wipes bin 41 and the dispensing dome 49 composed of soft flexible material bonded to the bin cover 48 are shown in section with the periphery of the dispensing dome 49 joined with the depressed portion of the bin cover 48.

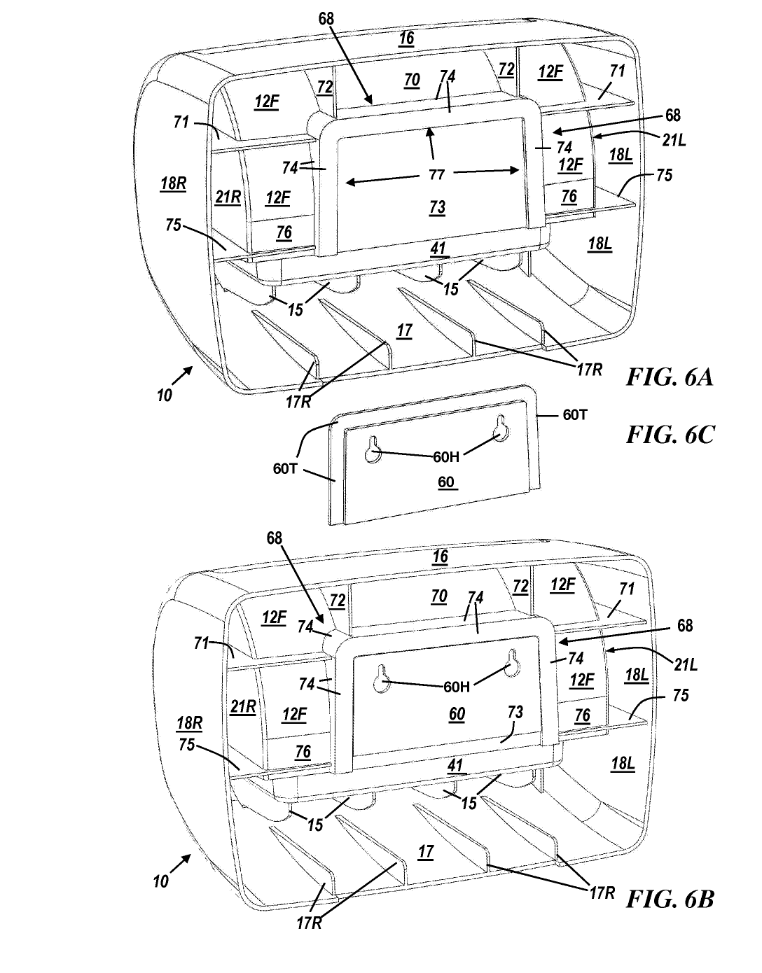

FIG. 4D is a sectional view of the wipes dispenser 9 of FIGS. 1A-1B, and 3A-3C; 4A and 4B taken along section line 4D-4D of FIG. 4C taken along the periphery of the bin rim 45. The bearing holes 20L/20R are seen on either end of the bin rim 45 that is shown in section around the rim of the wipes bin 41. The pair of bin alignment ribs 44 are shown extending across the width of the bottom 41B of the wipes bin 41. On the back of the cabinet 10 is a mounting frame 68 shown in perspective with a back 73, frame edges 74 and peripheral grooves 77 behind the frame edges 74 as shown in FIG. 6A with frame edges 74 of the mounting frame 68 adapted to receive peripheral tongues 60T of a mounting bracket 60 (shown in perspective in FIGS. 2E and 6B) in the peripheral grooves 77 behind the frame edges 74 for supporting the cabinet 10.

As shown in FIGS. 2E and 6B, the mounting bracket 60 includes the peripheral tongues 60T on the top and the sides thereof. The peripheral tongues 60T of mounting bracket 60 are adapted to be inserted into the grooves 77 behind the frame edges 74 of the mounting frame 68 as shown further in FIGS. 6A and 6B when the cabinet 10 is mounted on the mounting bracket 60 that is adapted to be secured to a wall by screws or the like thereby holding the mounting bracket in the mounting holes 60H through the bracket 60 shown in FIGS. 6B/6B.

FIG. 5A is a perspective view of the front of the cabinet 10 of FIG. 2A with the roll back door 12 opened with the door face 12F and the left sidewall 12L exposed.

FIG. 5B is a perspective view of the top of the bin gasket 46 that include a horizontally extending portion with the front tab 46T extending downwardly from it. The bin gasket 46 and its front tab 46T are composed of a soft gasket sealing material to provide a seal to inhibit drying of the wet wipes when the container 40 is assembled with the bin cover 48 closing the opening on top of the wipes bin 41. The bin gasket 46 including the front tab 46T is adapted to be bonded to the wipes bin 41 and the front plate 42. The rim 46R of the bin gasket 46 is to be bonded to the rim 45 (see FIG. 5C) of the wipes bin 41 and the front tab 46T is to be inserted into the notch 43 in the front plate 42 and bonded thereto.

FIG. 5C is a perspective view of the top of the wipes bin 41 assembled with the front plate 42 just below the bin gasket 46 and the front tab 46T, in a position ready to be assembled therewith. The rim 45 of wipes bin 41 is shaped to receive the bin gasket 46 and the notch 43 is shaped to receive the front tab 46T.

FIG. 5D is a perspective top view of the bin cover 48 of wipes bin 41 and the bellows rings 48B of bin cover 48 adapted to receive the dispensing dome 49.

FIG. 5E is a perspective top view of the dispensing dome 49 of the bin cover 48 with the dispensing slit 49S therethrough provided for dispensing wet wipes through the dispensing dome 49.

FIG. 5F is a perspective view of the top of the assembled parts of wipes container 40 of FIGS. 5-5E, with the container 40 juxtaposed with the cabinet 10 of FIG. 5A, ready to be inserted therein. In particular, the container 40 includes the bin gasket 46 of FIG. 5B, the wipes bin 41 of FIG. 5C, the bin cover 48 of FIG. 5D, and the dispensing dome 49 of FIG. 5E. The front tab 46T of the bin gasket 46 has been inserted into the notch 43 shown in FIG. 5C and has been bonded to the front plate 42. The front tab 46T of the bin gasket 46 shown separately in FIG. 5B, is assembled into the notch 43 and bonded to the front plate 42.

FIGS. 6A and 6B are rear perspective views of the back of the cabinet 10 of FIG. 1B with the door 12 open so that portions of the back of face 12F of the rollback door 12 and a portion of the bin 41 are visible.

FIG. 6C shows a mounting bracket 60 for supporting cabinet 10, with mounting holes 60H through the mounting bracket 60 and a tongue 60T of mounting bracket 60 for insertion into the grooves 77 behind the frame edges 74 of the mounting frame 68 to support the cabinet 10 as a fixture.

In FIGS. 6A/6B portions of the face 12F of the door 12 are visible with the main features comprising the support elements for the supporting the cabinet 10 for mounting on a wall, a cabinet or the like. The top 16 and left/right outside sidewalls 18L/18R of cabinet 10 are shown along with the left/right inside sidewalls 21L/21R of cabinet 10 that provide support for the mounting frame 68 with frame edges 74 shaped like an inverted U. The mounting frame 68 includes the frame edges 74 including a horizontal edge and two vertical edges extending downwardly from each end of the horizontal edge, as shown, with the grooves 77 shown in FIG. 6A therebehind.

The back 73 is bonded to the frame edges 74 behind the grooves 77 to provide a rigid structure for the cabinet 10 stabilizing the positions of the vertical frame edges 74 and parts bonded thereto apart. A central upper casing 70 and the lateral, upper vertical braces 72 are bonded to both the top 16 of cabinet 10 and to the top of the horizontal frame edge 74. Two lateral, upper vertical braces 72 are secured at one end to the interior surface of the top 16 of the cabinet 10 and are bonded at the other end to the top surface of the frame edges 74 of the mounting frame 68 to provide support therefor.

Horizontal braces 71 are bonded to the outer surfaces on the upper ends of the vertical frame edges 74 on one end of each thereof with the other end bonded to the left/right outside sidewalls 18L/18R of cabinet 10 to support the upper end of the mounting frame 68 laterally and stabilize the sidewalls 18L/18R. A portion of the bin 41 can be seen below the back 73.

The horizontal braces 71 are bonded to the left and right exterior sidewalls 18L/18R and to the upper lateral edges of the mounting frame 68. Each of a pair of lower horizontal braces 75 is bonded on one end to the lower edge of the mounting frame 68 and on the other end to one of the left outside cabinet sidewall 18L and the right outside cabinet sidewall 18R of cabinet 10. Two lower vertical braces 76 are bonded to the left/right inside sidewalls 21L/21R of cabinet 10 plus being bonded to one of the pair of lower horizontal braces 75, thereby holding both the mounting frame 68 and the left/right inside sidewalls 21L/21R in place.

In FIG. 6C the mounting bracket 60 includes the peripheral tongue 60T with an inverted U-shape that is adapted to retain the mounting frame 68 (adapted to connect the cabinet 10 to the mounting bracket 60) with the U-shaped grooves 77 in frame 68 sliding down onto the tongue 60T. There are mounting holes 60H through the mounting bracket 60 that are provided for fasteners such screws (not shown) for attachment of the mounting bracket 60 to a wall or other surface.

FIG. 7A is a sectional view, taken along line 7A-7A in FIG. 4A, of the wipes dispenser 9 including the cabinet 10 and the container 40 with the door 12 closed; and FIG. 7B is a similar sectional view, taken along line 7B-7B in FIG. 4B, of the wipes dispenser 9 including the cabinet 10 and the container 40, but with the door 12 open. FIGS. 7A/7B also show the wipes container 40 for moistened wipes including the wipes bin 41 of wipes container 40.

In FIGS. 7A/7B, structural elements of the cabinet 10 are shown including the roll back door 12, the face 12F, the door handle 14, fins 15 for alignment of wipes bin 41, alignment notches 15N in fins 15 for holding bin alignment ribs 44 of wipes bin 41 in place when the wipes bin 41 is installed in the cabinet 10, the top 16 of cabinet 10, and the cabinet bottom 17.

In addition, on the back of the cabinet 10 the mounting frame 68 is shown supported by an upper casing 70, a right upper vertical brace 72, and the back 73 of the mounting frame 68. The frame edges 74 of the mounting frame 68 are in the shape of an inverted U, and the grooves 77 are located behind the frame edges 74. The mounting bracket 60 is shown with the upper portion of the tongue 60T shown in the horizontal portion of the groove 77.

FIGS. 7A/7B show a side elevation section of the assembled parts of wipes container 40 of FIGS. 5A-5E, with the container 40 installed within the cabinet 10 of FIG. 5A. In particular, bin 41 of FIG. 5C is shown installed in the container 40. The rim 46R of the bin gasket 46 is shown installed on the container 40 of FIG. 5B. The bin cover 48 of FIG. 5D, and the dispensing dome 49 of FIG. 5E are shown with the dispensing slit 49S in dispensing dome 49 providing for removal of a wet wipe extending therethrough without removal of the bin cover 48 from the top of the bin 41. The dispensing slit is narrow enough to inhibit drying of wet wipes stored in the bin 41.

The front tab 46T of the bin gasket 46 of FIG. 5B, is assembled into the notch 43 and bonded to the front plate 42. The lower surfaces of the bin alignment ribs 44 in bottom 41B of wipes bin 41 for alignment of wipes bin 41 in cabinet 10 are shown installed into the notches 15N in the fins 15 for maintaining alignment of wipes bin 41 when it is installed on the fins 15 in the cabinet 10. The front plate 42 encloses the space below the handle 14 of the door 12 as shown in FIG. 7A to provide a seal of the space within the cabinet 10 in order to inhibit evaporation of fluid from wet wipes stored in the container 40 and the bin 41.

FIG. 7B shows how the cover 48 can be removed from the top of the bin 41 to remove a wet wipe from it or to replenish a stack of wet wipes therein.

Materials that may be used as the hard plastics of the cabinet 10 and the container 40 include Acrylonitrile-Butadiene-Styrene (ABS) polypropylene; polyesters such as Poly(butylene terephthalate) “PBT”; PBT glass filled; PBT 15% glass filled; polycarbonate; polyvinyl chloride; metal; fiberglass; and carbon fiber.

An example of a flexible material suitable for the bin gasket 46 and the dispensing dome 49 include Thermo-Plastic-Elastomeric (TPE) materials that can be used to provide acceptable dispensing. Materials that can be employed include (but are not limited to): any of the family of styrenic-based TPE's (i.e. styrenic block copolymer compounds); styrenic-based TPE's containing rubber modifiers such as Kraton®, Santoprene®, or other rubber modifiers; Kraton®; Santoprene®; specialty copolymers, such as ethylene-methyl acrylate copolymers such as EMAC®; thermoset rubbers; polyurethane; alloys; amides; engineering TPE's; olefinic-based; olefinic vulcanizates; polyester-based; polyurethane-based. One such material for the flexible, rubber-like sheet.

While the primary description of the wet wipes have been directed to devices configured for use in the bathroom or for dispensing wet wipes materials of comparable size, it will be seen that no limitations have been placed upon the size or dimensions of the dispenser. The foregoing description discloses only exemplary embodiments of the invention. Modifications of the above disclosed apparatus and methods that fall within the scope of the invention will be readily apparent to those of ordinary skill in the art. While this invention is described in terms of the above specific exemplary embodiment(s), those skilled in the art will recognize that the invention can be practiced with modifications within the spirit and scope of the appended claims, i.e. changes can be made in form and detail, without departing from the spirit and scope of the invention.

Accordingly, while the present invention is disclosed in connection with exemplary embodiments thereof, it should be understood that changes can be made to provide other embodiments that may fall within the spirit and scope of the invention and all such changes come within the purview of the present invention and the invention encompasses the subject matter defined by the following claims. In other words, it is to be understood that the present invention is not limited to the embodiments described above, but encompasses any and all embodiments within the scope of the following claims.

What is claimed is:

1. A wipes dispenser for wet wipes comprising:
a cabinet with an exterior structure enveloping an interior space and with a roll back door rotatable between opened and closed positions providing access to said interior space; and
a wipes container housing a wipes bin in said interior space in said cabinet.

2. The wipes dispenser of claim 1 including:
a mounting structure formed on said cabinet; and
a mounting support for affixing said mounting structure to a support surface.

3. The wipes dispenser of claim 1 wherein said cabinet includes a rigid supporting structure for installing said wipes bin therein.

4. The wipes dispenser of claim 1 wherein:
said cabinet includes fins affixed thereto located within said interior space with said fins having notches formed thereon;
said wipes bin includes a bottom with ribs formed therein for installation into said notches.

5. The wipes dispenser of claim 1 including:
a front plate comprising an element of said exterior structure located below said roll back door in a closed position thereof;
a gasket sealing surfaces between said cover and said bin with a tab extending therefrom; and
said tab of said gasket is bonded to said front plate.

6. The wipes dispenser of claim 1 wherein:
said cabinet includes sidewalls; and
said rollback door and said sidewalls have simple bearings formed therein for supporting rolling of said rollback door between an opened position and a closed position.

7. The wipes dispenser of claim 2 wherein said cabinet includes a rigid supporting structure for installing said wipes bin therein.

8. The wipes dispenser of claim 2 wherein:
said cabinet includes fins affixed thereto located within said interior space with said fins having notches formed thereon; and
said wipes bin includes a bottom with ribs formed therein for installation into said notches.

9. The wipes dispenser of claim 2 including:
a front plate comprising an element of said exterior structure located below said roll back door in said closed position;
a gasket sealing surfaces between said cover and said bin with a tab extending therefrom; and
said tab of said gasket bonded to said front plate.

10. The wipes dispenser of claim 2 wherein:
said cabinet includes sidewalls; and
said rollback door and said sidewalls have simple bearings formed therein for supporting rolling of said rollback door between opened and closed positions.

11. A wipes dispenser for wet wipes comprising:
a cabinet with an exterior structure enveloping an interior space and with a roll back door providing access to said interior space by rolling between an opened position and a closed position;
said cabinet including cabinet sidewalls;
said roll back door having a curved front face with a circular radius and a handle thereon and door sidewalls;
said roll back door being mounted on simple bearings comprising bearing holes in said cabinet sidewalls and pins on said door sidewalls installed in said bearing holes;
a wipes container housing a wipes bin in said interior space in said cabinet;
a mounting structure formed on said cabinet; and
a mounting support for affixing said mounting structure to a support surface.

12. The wipes dispenser of claim 11 wherein said cabinet includes a rigid supporting structure for installing said wipes bin therein.

13. The wipes dispenser of claim 11 wherein:
said cabinet includes fins affixed thereto located within said interior space with said fins having notches formed thereon;
said wipes bin includes a bottom with ribs formed saidrein for installation into said notches.

14. The wipes dispenser of claim 11 including:
a front plate comprising an element of said exterior structure located below said roll back door in said closed position;
a gasket sealing surfaces between said cover and said bin with a tab extending therefrom; and
said tab of said gasket bonded to said front plate.

15. The wipes dispenser of claim 1 wherein said bin includes a cover with a dispensing dome with a dispensing slit therethrough.

16. The wipes dispenser of claim 11 wherein said bin includes a cover with a dispensing dome with a dispensing slit therethrough.

17. The wipes dispenser of claim 1 wherein said bin includes a cover with a dispensing dome with a dispensing slit therethrough, wherein said dispensing dome is composed of a soft, flexible plastic.

18. The wipes dispenser of claim 11 wherein said bin includes a cover with a dispensing dome with a dispensing slit therethrough, wherein said dispensing dome is composed of a soft, flexible plastic.

19. The wipes dispenser of claim 1 wherein said cabinet and said bin are composed of hard plastic and said bin includes a cover with dispensing dome with a dispensing slit therethrough wherein said dispensing dome is composed of a soft, flexible plastic.

20. The wipes dispenser of claim 11 wherein said cabinet and said bin are composed of hard plastic and said bin includes a cover with dispensing dome with a dispensing slit therethrough wherein said dispensing dome is composed of a soft, flexible plastic.
